(19) United States
(12) Patent Application Publication
(10) Pub. No.: US 2020/0134542 A1
(43) Pub. Date: Apr. 30, 2020

(54) IMPLEMENTING PRIORITIZED ORDER SCORING

(71) Applicant: International Business Machines Corporation, Armonk, NY (US)

(72) Inventors: Jason T. Albert, Rochester, MN (US); Matt K. Light, Rochester, MN (US); Matthew J. Scheckel, Rochester, MN (US); Kahn C. Evans, Rochester, MN (US); Steven B. Janssen, Rochester, MN (US)

(21) Appl. No.: 16/171,576

(22) Filed: Oct. 26, 2018

(51) Int. Cl. G06Q 10/08; G06Q 30/06; H04W 4/029; H04W 4/02

(52) U.S. Cl. CPC G06Q 10/087; G06Q 10/0838; H04W 4/025; H04W 4/029; G06Q 30/0635

(57) ABSTRACT

A method, system and computer program product are provided for implementing enhanced prioritized order scoring based upon user location and user history. A prioritized order score used for work prioritization is calculated using user location and user history. A respective prioritized order score is identified for an ordered pickup location and an alternative pickup location. The identified prioritized order scores are compared to identify a location for the order.

### FIELD OF THE INVENTION

The present invention relates generally to the data processing field, and more particularly, relates to a method, system and computer program product for implementing prioritized order scoring based upon user location and history.

### SUMMARY OF THE INVENTION

Principal aspects of the present invention are to provide a method, system and computer program product for implementing enhanced prioritized order scoring based upon user location and user history. Other important aspects of the present invention are to provide such method, system and computer program product substantially without negative effects and that overcome many of the disadvantages of prior art arrangements.

In brief, a method, system and computer program product are provided for implementing enhanced prioritized order scoring based upon user location and user history. A prioritized order score used for work prioritization is calculated using user location and user history. A respective prioritized order score is identified for an ordered pickup location and an alternative pickup location. The identified prioritized order scores are compared to identify a pickup location for the order.

In accordance with features of the invention, identifying the alternative business location for the order, the order optionally is automatically rerouted so that it is ready for the customer at a new location, for example, when it is detected that the customer is going to the wrong location.

In accordance with features of the invention, a calculation of priority score (S score) optionally is represented by:

S score=(PT pickup time−ET estimated time)+(ΣPT pickup history),

where the higher the priority score S score, the higher in the order queue,
PT pickup time represents the pickup time given to the customer,
ET represents the estimated time for the customer's arrival based upon location data and traffic travel time, and
ΣPT pickup history represents a sum of the customer's pickup history, with each previous pickup given a value for each late pickup, another value for each on time pickup, and another value for each early pickup, for example, with −1 for each late pickup, 0 for each on time pickup, and 1 for each early pickup.

In accordance with features of the invention, base weighting are added to location and history factors to adjust for business preference where location weight is the weight given to the location factors, and history weight given to the history factors.

In accordance with features of the invention, calculation of priority score (S score) optionally uses another factor of the history of the location where the order is placed into the scoring for the queue. For example, when a customer consistently places an order from the same location and is on time, that factor can be used to raise their calculated score.

In accordance with features of the invention, a user's response when the order is being rerouted is employed to train the system. When the user asks to have the order rerouted, this is incorporated into the system.

In accordance with features of the invention, the use of identified prioritized order scores to identify a pickup location for the order enables associated businesses to effectively manage staff and demands, and increases customer satisfaction

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 provides a block diagram of an example computer system for implementing enhanced prioritized order scoring based upon user location and history in accordance with preferred embodiments;

FIGS. 2 and 3 are respective flow chart illustrating example system operations to implement enhanced prioritized order scoring based upon user location and history of FIG. 1 in accordance with preferred embodiments; and

FIG. 4 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and system are provided for implementing enhanced prioritized order scoring based upon user location and history.

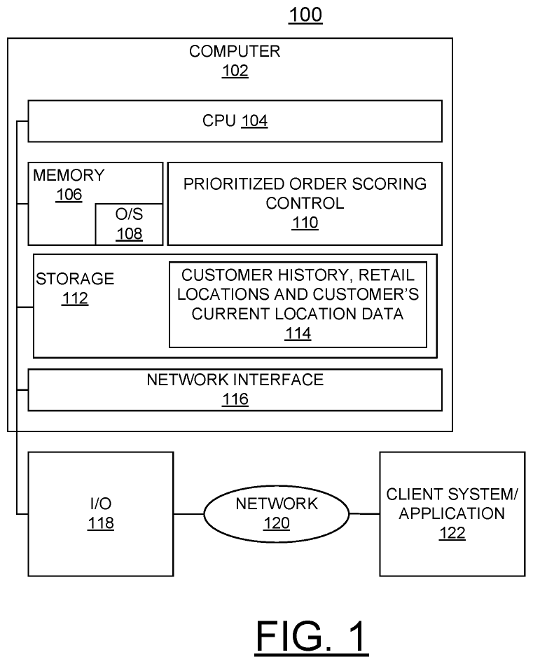

Having reference now to the drawings, in FIG. 1, there is shown an example system embodying the present invention generally designated by the reference character 100 for implementing enhanced prioritized order scoring based upon user location and history in accordance with preferred embodiments. System 100 includes a computer system 102 including one or more processors 104 or general-purpose programmable central processing units (CPUs) 104. As shown, computer system 102 includes a single CPU 104; however, system 102 can include multiple processors 104 typical of a relatively large system.

Computer system 102 includes a system memory 106 including an operating system 108 and a prioritized order scoring control 110 in accordance with preferred embodiments. System memory 106 is a random-access semiconductor memory for storing data, including programs. System memory 106 is comprised of, for example, a dynamic random access memory (DRAM), a synchronous direct random access memory (SDRAM), a current double data rate (DDRx) SDRAM, non-volatile memory, optical storage, and other storage devices.

Computer system 102 includes a storage 112 including a customer history, retail locations and customer's current location data 114 in accordance with preferred embodiments and a network interface 116. Computer system 102 includes an I/O interface 118 for transferring data to and from computer system components including CPU 104, memory 106 including the operating system 108 and prioritized order scoring control, storage 112 including a customer history, retail locations and customer's current location data 114, and network interface 116 and a network 120 and a client system and application 122.

In accordance with features of the invention, the new computer system 102 of the preferred embodiment implements enhanced prioritization of order processing based upon user location and history. The enhanced order prioritization enables associated businesses to more effectively manage staff and demands, and increasing customer satisfaction.

In accordance with features of the invention, the enhanced order prioritization enables just in time order preparation for delivery to the customer, which is an important feature for customer and the associated businesses, particularly for perishable orders, such as many food orders.

In accordance with features of the invention, the enhanced order prioritization enables recognition of an order being placed to a wrong location and a customer mistakenly traveling to a wrong location. Multiple local retail locations are stored in the system. When the system identifies a prioritized order score continuing to decrease from the ordered location while increasing towards an alternative business location, the order is recognized as being placed to the wrong location.

In accordance with features of the invention, the enhanced order prioritization enables, for example, automatically rerouting an order so that it is ready for the customer at a new location when it is detected that the customer may be going to the wrong location. The customer is notified of this change. The customer is notified that the address of the mistaken location was entered and the new destination information is provided to the customer. A customer's destination information is incorporated into the redirect notification decision. Thus, for example, with the system knowing the user's history, it can determine that at 5 p.m. during the week, the customer travels from their office to their home. While the customer may pass by an alternative restaurant on their drive home, the system suppresses any notification since the user selected pickup location is close to their home.

In accordance with features of the invention, a user's response is employed to train the system, for example if the user has taken a detour and declines to have their order rerouted, to suppress future notifications under similar circumstances. When the user asks to have the order rerouted, this also is incorporated into the system. The user is notified when a future order is placed at a similar time of day and place, suggesting to the user when placing the order the new pickup location that was used last time.

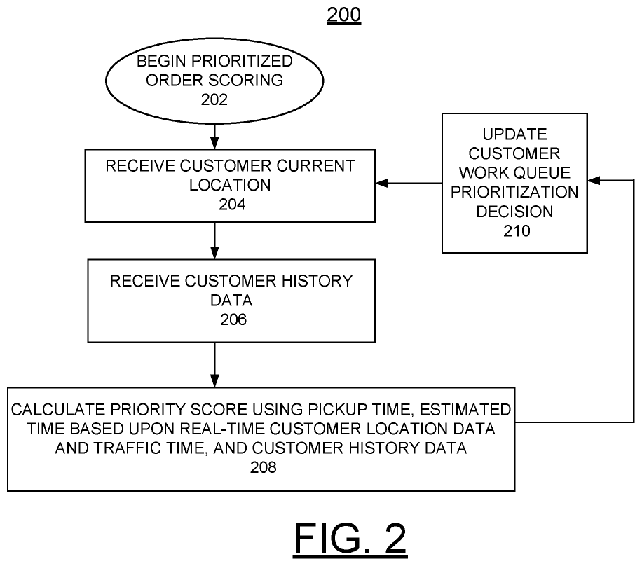

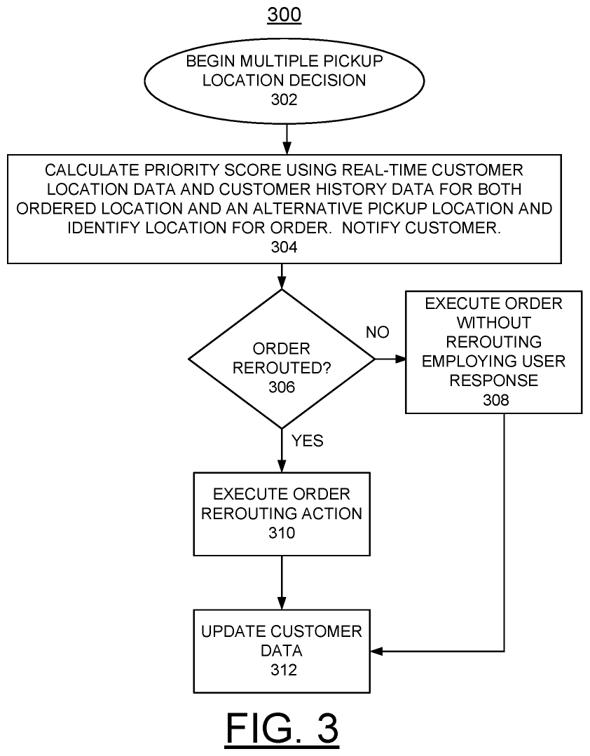

Referring to FIGS. 2 and 3, there are shown example system operations generally designated by the reference characters 200 and 300 of computer system 102 of FIG. 1, for implementing enhanced prioritized order scoring based upon user location and history in accordance with preferred embodiments.

Referring to FIG. 2, prioritized order scoring operations begin as indicated at a block 202. As indicated at a block 204, a current location of the customer is received. As indicated in a block 206, customer history data of the customer is received. As indicated in a block 208, calculation of a priority score is performed. The priority score is calculated using a pickup time, an estimated time based upon real-time customer location data and traffic time, together with customer history data. For example, a calculation of priority score (S score) optionally is represented by:

S score=(PT pickup time−ET estimated time)+(ΣPT pickup history),

where the higher the priority score S score, the higher in the order queue,
PT pickup time represents the pickup time given to the customer,
ET represents the estimated time for the customer's arrival based upon location data and traffic travel time, and
ΣPT pickup history represents a sum of the customer's pickup history, with each previous pickup given a value, for example, of −1 for each late pickup, 0 for each on time pickup, and 1 for each early pickup.

As another example, a calculation of priority score (S score) using base weighting added to location and history factors is used to adjust for business preference, and optionally is represented by:

S score=LW location weight (PT pickup time−ET estimated time)+HW history weight (ΣPT pickup history),

where LW location weight is the weight given to the location factors, and
HW history weight given to the history factors, and can be any selected numerical value. For example, a heavy history weighting can put preference on past behavior, while still accommodating real-time location data.

As another example, a calculation of priority score (S score) using another factor of the history of the location where the order is placed into the scoring for the queue. For example, when a customer consistently places an order from the same location and is on time, that factor advantageously is used to raise their score. When a new order location is seen, that has no impact on the scoring. The calculation of priority score (S score) using the location of the order is represented by:

S score=LW location weight ((PT pickup time−ET estimated time)+OL order location)+HW history weight (ΣPT pickup history),

where the OL order location is a selected factor increasing the calculated priority score. Following the calculation of priority score (S score) as indicated in a block 210, a customer work queue prioritization decision is updated.

Referring now to FIG. 3, there are shown example system operations of computer system 102 of FIG. 1, for implementing enhanced prioritized order scoring based upon user location and history in accordance with preferred embodiments starting at a block 302 where processing multiple pickup locations begins. As indicated at a block 304, calculation of a priority score is performed. At block 304, the priority score calculation is performed using real-time customer location data and customer history data for both an ordered location and an alternative pickup location and the user is notified of the new location for the order. At block 304, the enhanced order prioritization provides recognition of an order being placed to a wrong location and a customer mistakenly traveling to a wrong location and the user notification is provided. Multiple local retail locations are stored in the system. When a prioritized order score continuing to decrease from the ordered location while increasing towards an alternative business location are identified, the order is recognized as being placed to the wrong location. The customer's new destination information is incorporated into the customer notification that the address of the mistaken location was entered and the new destination information is provided to the customer

As indicated at a decision block 306, determining whether to provide for an order being rerouted is performed. When determined that the order is not rerouted based on the user's response, the order without rerouting is executed employing the user response as indicated at a block 308. When determined that the order is rerouted, the order is rerouted using the alternative business location of the order at block 304 so that it is ready for the customer at a new location when it is detected that the customer may be going to the wrong location as indicated at a block 310.

Then customer data is updated as indicated at a block 312 following the actions taken at respective blocks 308 and 310. The user's response is employed to train the system at 312, for example, if the user has taken a detour and declines to have their order rerouted, the history data is updated to suppress future notifications under similar circumstances. When the user asks to have the order rerouted, this also is incorporated into the system. The user is notified when a future order is placed at a similar time of day and place, then suggesting to the user is performed to indicate that when placing the order, the new pickup location that was used last time using the updated customer data at block 312.

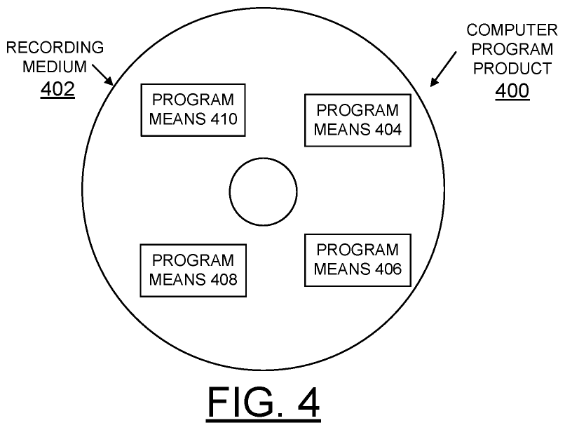

Referring now to FIG. 4, an article of manufacture or a computer program product 400 of the invention is illustrated. The computer program product 400 is tangibly embodied on a non-transitory computer readable storage medium that includes a recording medium 402, such as, a floppy disk, a high capacity read only memory in the form of an optically read compact disk or CD-ROM, a tape, or another similar computer program product. The computer readable storage medium 402, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Recording medium 402 stores program means or instructions 404, 406, 408, and 410 on the non-transitory computer readable storage medium 402 for carrying out the methods for implementing enhanced prioritized order scoring based upon user location and user history in the system 100 of FIG. 1.

Computer readable program instructions 404, 406, 408, and 410 described herein can be downloaded to respective computing/processing devices from a computer readable storage medium or to an external computer or external storage device via a network, for example, the Internet, a local area network, a wide area network and/or a wireless network. The computer program product 400 may include cloud based software residing as a cloud application, commonly referred to by the acronym (SaaS) Software as a Service. The network may comprise copper transmission cables, optical transmission fibers, wireless transmission, routers, firewalls, switches, gateway computers and/or edge servers. A network adapter card or network interface in each computing/processing device receives computer readable program instructions 404, 406, 408, and 410 from the network and forwards the computer readable program instructions for storage in a computer readable storage medium within the respective computing/processing device.

A sequence of program instructions or a logical assembly of one or more interrelated modules defined by the recorded program means 404, 406, 408, and 410, direct the system 100 for enhanced prioritized order scoring based upon user location and user history of the preferred embodiment.

While the present invention has been described with reference to the details of the embodiments of the invention shown in the drawing, these details are not intended to limit the scope of the invention as claimed in the appended claims.

What is claimed is:

1. A system for implementing enhanced prioritized order scoring based upon user location and history comprising:
a prioritized order scoring control logic,
said prioritized order scoring control logic tangibly embodied in a non-transitory machine readable medium used to implement enhanced prioritized order scoring;
said prioritized order scoring control logic, calculating a prioritized order score used for work prioritization; and
said prioritized order scoring control logic, identifying a respective prioritized order score for an ordered pickup location and an alternative pickup location, and
said prioritized order scoring control logic, comparing the identified prioritized order scores, and identifying a pickup location for the order.

2. The system as recited in claim 1, wherein said prioritized order scoring control logic, identifying a respective prioritized order score includes receiving and storing user location and user history data.

3. The system as recited in claim 2, includes storing multiple retail locations.

4. The system as recited in claim 1, further comprising said prioritized order scoring control logic:
updating the user location;
calculating an updated prioritized order score user for work prioritization using the updated user location;
identifying a respective updated prioritized order score for the ordered pickup location and the alternative pickup location; and
identifying a decrease in score relative to the ordered pickup location and an increase in score relative to the alternative pickup location.

5. The system as recited in claim 4, further comprising said prioritized order scoring control logic, automatically rerouting the order to the alternative pickup location, and updating the user history.

6. The system as recited in claim 4, further comprising said prioritized order scoring control logic, notifying the customer of the alternative pickup location, receiving a user response, and updating the user history to train the system.

7. The system as recited in claim 1, includes rerouting the order to the alternative pickup location enabling associated businesses to effectively manage staff and demands, and increasing customer satisfaction.

8. The system as recited in claim 1, wherein said prioritized order scoring control logic, identifying a respective prioritized order score includes calculating the respective prioritized order score using a pickup time given to the customer, and an estimated time for the customer's arrival based upon location data and traffic travel time, and a sum representing a customer's pickup history.

9. The system as recited in claim 1, includes control code stored on a non-transitory computer readable medium, and wherein said control code implements said prioritized order scoring control logic using stored customer history, retail locations and customer current location.

10. A method for implementing enhanced prioritized order scoring based upon user location and history comprising:
calculating a prioritized order score used for work prioritization;
identifying a respective prioritized order score for an ordered pickup location and for an alternative pickup location, and
comparing the identified prioritized order scores, and identifying a pickup location responsive to the compared values.

11. The method as recited in claim 10, includes providing prioritized order scoring control logic tangibly embodied in a non-transitory machine readable medium used to implement enhanced prioritized order scoring.

12. The method as recited in claim 10, includes receiving and storing user location and user history data.

13. The method as recited in claim 10, includes receiving and storing multiple retail locations.

14. The method as recited in claim 10, wherein comparing the identified prioritized order scores, and identifying a pickup location includes identifying a decrease in score relative to the ordered pickup location and an increase in score relative to the alternative pickup location.

15. The method as recited in claim 14, includes automatically rerouting the order to the alternative pickup location, and updating the user history.

16. The method as recited in claim 14, includes notifying the customer of the alternative pickup location, receiving a user response, and updating the user history to train the system.

17. The method as recited in claim 10, includes rerouting the order to the alternative pickup location enabling associated businesses to effectively manage staff and demands, and increasing customer satisfaction.

18. The method as recited in claim 10, wherein identifying a respective prioritized order score includes calculating the respective prioritized order score using a pickup time given to the customer, and an estimated time for the customer's arrival based upon location data and traffic travel time, and a sum representing a customer's pickup history.

19. The method as recited in claim 18, includes using base weighting added to location and history factors in calculating the respective prioritized order score to adjust for business preference, where the location weight is the weight applied to the location factors, and the history weight is applied to the history factors.

20. The method as recited in claim 10, includes providing control code stored on a non-transitory computer readable medium, and wherein said control code implements prioritized order scoring control using stored customer history, retail locations and customer current location.
